(19) United States
(12) Patent Application Publication
(10) Pub. No.: US 2025/0108509 A1
(43) Pub. Date: Apr. 3, 2025

(54) SYSTEM AND A METHOD FOR DEFINING MISSIONS TO ROBOTS WITH DIFFERENT NAVIGATION CAPABILITIES

(71) Applicant: INDOOR ROBOTICS LTD., Ramat-Gan (IL)

(72) Inventors: DORON BEN-DAVID, PETACH TIKVA (IL); AMIT MORAN, TEL-AVIV (IL)

(21) Appl. No.: 18/375,557

(22) Filed: Oct. 2, 2023

(51) Int. Cl. B25J 9/16; B25J 5/00

(52) U.S. Cl. CPC B25J 9/1664; B25J 5/007; B25J 9/1661

(57) ABSTRACT

Defining missions for robots by creating predefined plans for a mobile robot, receiving a mission, computing a mission location for performing the mission, in case the navigation capabilities of the mobile robot are not sufficient to reach the mission location in an autonomous manner, computing a target location that appears in the predefined plans known to the mobile robot and is sufficiently close to the mission location, generating a mission command to be sent to the mobile robot, the mission command comprises a command to perform the mission by moving to the target location, whereupon the mobile robot moves to the target location.

### FIELD

The invention relates generally to a robotics system comprising mobile robots with different navigation capabilities.

### BACKGROUND

Use of robots increases to facilitate life, in addition to facilitating commercial activities, such as manufacturing, medical operations, customer service, and the like. Robots clean our houses, deliver goods from one place to another, function as mobile sensors, provide communication to lonely people, and have many more functions. These robots are equipped with an actuation mechanism, such as a motor, a power source, mostly a rechargeable battery, and an operating module that performs the mission required by the robot. Such an operating module may be a cleaning module such as a vacuum cleaner, may be a camera in case the robot is a surveillance or monitoring robot, may be a processor, speaker, and audio sensor for communicating with another person and others. The robot may include a wireless communication module for exchanging information with another electronic device.

In many cases, when there is a need for complex missions (as opposed to floors cleaned by autonomous robots), such missions may be supervised by a computer that communicates with the mobile robot. As such, companies that require monitoring of indoor spaces may need a fleet of robots and a server to manage the robots. Due to various reasons, such as supply chain challenges, regulation, costs, and others, companies may purchase robots with limited navigation capabilities, for example, robots that are unable to localize themselves with sufficient accuracy. There is a need for methods for using robots with limited navigation capabilities to perform the same missions as robots with sufficient navigation capabilities.

### SUMMARY

In one aspect of the invention a method is provided for defining missions to robots, the method comprising creating predefined plans for a mobile robot; receiving a mission; computing a mission location for performing the mission; in case the navigation capabilities of the mobile robot are not sufficient to reach the mission location in an autonomous manner, computing a target location that appears in the predefined plans known to the mobile robot and is sufficiently close to the mission location; generating a mission command to be sent to the mobile robot, the mission command comprises a command to perform the mission by moving to the target location; the mobile robot moving to the target location.

In some cases, the method is performed by an external compute device communicating with multiple mobile robots having different levels of navigation capabilities; said method further comprises identifying the level of navigation capabilities of the mobile robot selected to perform the mission. In some cases, the method further comprises computing a closest point in the path, wherein the closest point is closest to the mission location, wherein sending the mobile robot to the closest point. In some cases, the method further comprises computing the closest point along the paths to target objects in the indoor facility, said target objects are likely to be involved in a mission. In some cases, the method further comprises identifying one or more relevant points in the path, wherein the one or more relevant points have a distance to the mission location, wherein the distance is smaller than a threshold and sending the mobile robot to the closest point.

In some cases, the method further comprises uploading a map to the mobile robot's memory and configuring missions based on the map. In some cases, creating the predefined plans further comprises moving the new mobile robot along paths in the indoor facility. In some cases, the method further comprises storing locations and time stamps of the mobile robot along the paths. In some cases, the method further comprises verifying locations in the indoor facility by matching features in the indoor facility to known locations of the features. In some cases, the method further comprises selecting the mobile robot to handle the mission from multiple optional mobile robots and issuing a mission command based on navigation capabilities of the mobile robot. In some cases, the method further comprises monitoring the location of the mobile robot while the mobile robot moves to the target location. In some cases, the method further comprises monitoring the mobile robot while the mobile robot executes the mission and sending additional commands according to messages representing status of the mission over time.

### BRIEF DESCRIPTION OF THE DRAWINGS

The invention may be more clearly understood upon reading of the following detailed description of non-limiting exemplary embodiments thereof, with reference to the following drawings, in which:

FIG. 1 shows a computerized environment having multiple mobile robots and multiple dock stations, according to exemplary embodiments of the invention.

FIG. 2 shows the schematic components of a mobile robot, according to exemplary embodiments of the invention.

FIG. 3 shows a method for preparing a central computing device and mobile robots with limited navigation capabilities, according to exemplary embodiments of the invention.

FIG. 4 shows a method for handling missions by a system that comprises a central unit and one or more robots with limited navigation capabilities, according to exemplary embodiments of the invention.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

Illustrative embodiments of the invention are described below. In the interest of clarity, not all features/components of an actual implementation are necessarily described.

A technical challenge addressed by the invention is a case in which a specific facility requires missions to be handled by multiple robots, and due to various reasons, the multiple robots are of various manufacturers or have different navigation capabilities. Another technical challenge is a case in which there is a single robot with limited navigation capabilities. Due to the different navigation capabilities, an external computing device that manages these missions cannot use the same command, or the same set of rules, for all the robots in the specific facility. For example, some robots are fully autonomous, and the external computing device can send coordinates and positioning/orientation of a location in order for the autonomous robot to move to the desired location, while other robots used to perform missions by the same external computing device in the same facility only have limited navigation capabilities and require a different command. The different command includes data that replaces the coordinates sent to the autonomous robot. The term “navigation” in the context of the invention includes routing, route-planning, orientation, positioning and localization of the robots, in the sense that the robot can identify its location to a sufficient level of accuracy without using a remote device. The external computing device may be a server, a server placed in a cloud-based service such as AWS, in a local area, or in another robot.

The invention is useful in addressing a case in which there is a single robot with limited navigation capabilities. The invention, in embodiments thereof, provides a system and method for operating one or more mobile robots to execute missions. The solution of the claimed invention may address a case in which the robots have different navigation capabilities, in the sense that a first set of the robots have sufficient navigation capabilities while a second set of the robots have insufficient navigation capabilities. sufficient navigation capabilities are defined as capabilities that enable the robot to perform a mission while navigating to a mission location with a sufficient level of accuracy. That is, when the external computing device commands a mobile robot to perform or execute a mission, the command may include the coordinates relevant to the mission in case the robots have absolute navigation capabilities. When the robot assigned to perform the mission has relative navigation capabilities, the external computing device sends data representing the coordinates based for example, on a setup phase in which the robot moved in the facility. Such data representing the coordinates may be in the form of “path #14, time stamp 01:25:63” or “path 22, 16.3 meters from the beginning”. Such paths are already stored in the memory of the robot that has relative navigation capabilities, or in a memory accessible to the robot, so the robot needs only to move according to the path in the setup phase.

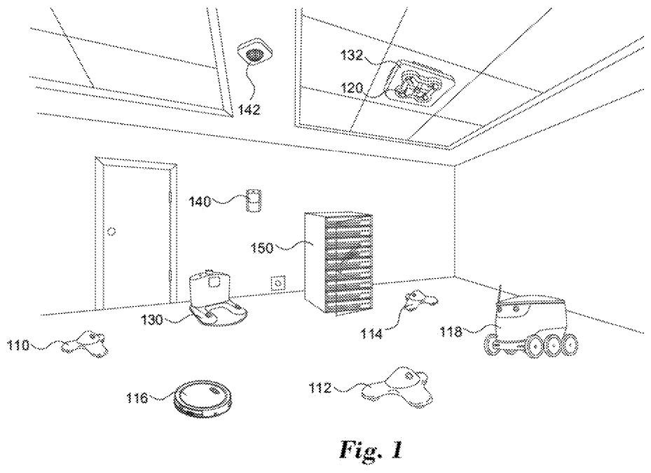

FIG. 1 discloses a computerized environment having multiple mobile robots and multiple dock stations, according to exemplary embodiments of the invention. The mobile robots 110, 112, 114, 116, 118 and 120 comprise an actuation mechanism enabling independent movement of the mobile robots. In other words, the robots' movement does not require a third party moving the robots from one place to another. The term “robot” as used below is defined as a “mobile robot” capable of moving independently. The mobile robots 110, 112, 114, 116, 118 and 120 also include a power source, for example connection to the electricity grid, a battery, a solar panel and charger and the like. The battery may be charged by a dock station, selected from dock stations 130, 132.

Each dock station of dock stations 130, 132 may enable one or more of the mobile robots 110, 112, 114, 116, 118 and 120 to dock thereto. Docking may provide the mobile robots 110, 112, 114, 116, 118 and 120 with electrical voltage, in case the dock stations 130, 132 are coupled to a power source. The dock stations 130, 132 may have communication connectivity, such as a cellular modem or internet gateway, enabling the dock stations 130, 132 to transfer information from the mobile robots 110, 112, 114, 116, 118 and 120 to a remote device such as a server or a central control device 150. The dock stations 130, 132 may be secured to a wall, a floor, the ceiling, or to an object in the area, such as a table. The dock stations 130, 132 may be unsecured dock-stations, for example a mobile robot with a big battery or an extension cord connected to the mobile robot may function as a dock station, charging another robot.

The central control device 150 may be a computer, such as a laptop, personal computer, server, tablet computer and the like. The central control device 150 may store a set of rules configured to determine which of the mobile robots to be sent to perform a mission. The central control device 150 may comprise an input unit enabling users to input missions therein. The input unit may be used to input constraints, such as maximal number of missions per time unit. The central control device 150 may be coupled to at least a portion of the mobile robots 110, 112, 114, 116, 118 and 120, for example in order to send commands to the robots, to receive a location of the robots, and additional information, such as technical failure of a component in the robot, battery status, mission status and the like. In some cases, the computerized environment lacks the central control device 150, and one or more of the mobile robots 110, 112, 114, 116, 118 and 120 perform the missions described with regard to the central control device 150.

The computerized environment may also comprise a sensor unit comprising one or more sensors 140, 142. The sensors 140, 142 may be image sensors for capturing images, temperature sensor, humidity sensor, audio sensor, LIDAR sensor and the like. The sensors 140, 142 of the sensor unit may be secured to a certain object, such as a wall, shelf, table, ceiling, floor and the like. The sensors 140, 142 of the sensor unit may collect information at a sampling rate and send the collected information to the central control device 150. The sensors 140, 142 of the sensor unit may have a processing unit which determines whether or not to send the collected information to the remote device, such as to one or more of the mobile robots 110, 112, 114, 116, 118 and 120 or the central control device 150.

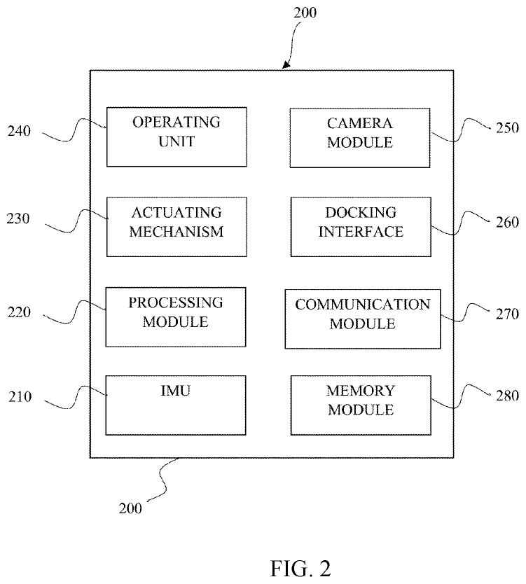

FIG. 2 shows schematic components of a mobile robot, according to exemplary embodiments of the invention. The mobile robot 200 comprises an operating unit 240 dedicated to perform a mission. The operating unit 240 may comprise one or more arms or another carrying member for carrying an item. The carrying member may be a magnetic plate for securing a metallic object. The operating unit 240 may comprise a container for containing a material, for example water, paint, sanitation material, perfume, beverages, a cleaning material, in case the mission is to provide a material to a certain place or person. The operating unit 240 may be a sensor for sensing information in a certain location, said sensor may be an image sensor, audio sensor, temperature sensor, odor sensor, sensor for detecting presence of a material and the like.

The mobile robot 200 comprises an actuation mechanism 230 for moving the mobile robot 200 from one place to another. The actuation mechanism 230 may comprise a motor, an actuator and any mechanism configured to maneuver a physical member. The actuation mechanism 230 may comprise a rotor of some sort, enabling the mobile robot 200 to fly. The actuation mechanism 230 is coupled to a power source, such as a battery or a renewable energy member, such as a solar panel in case the area comprises or is adjacent to an outdoor area accessible to the mobile robot 200. The actuation mechanism 230 may move the mobile robot 200 in two or three dimensions.

The mobile robot 200 may also comprise an inertial measurement unit (IMU) 210 configured to measure the robot's linear acceleration and angular velocities. The measurements collected by the IMU 210 may be transmitted to a processing module 220 configured to process the measurements. The IMU 210 may comprise one or more sensors, such as an accelerator, a gyroscope, a compass or magnetometer, a barometer and any the like.

The processing module 220 is configured to control the missions, and other actions, performed by the mobile robot 200. Thus, the processing module 220 is coupled to the actuation mechanism 230 configured to move the mobile robot 200. Such coupling may be via an electrical channel or cable, wireless communication, magnetic-based communication, optical fibers and the like. The processing module 220 may send a command to the actuation mechanism 230 to move to a certain location associated with a mission. The command may include instructions as to how to move to the certain location. The processing module 220 as defined herein may be a processor, controller, microcontroller and the like. The processing module 220 may be coupled to a communication module 270 via which the missions are received at the mobile robot 200. The communication module 270 may be configured to receive wireless signals, such as RF, Bluetooth, Wi-Fi and the like. The mobile robot 200 may also comprise a camera module 250 including one or more cameras for capturing images and/or videos.

The mobile robot 200 may comprise a memory module 280 configured to store information. For example, the memory module 280 may store prior locations of the mobile robot 200, battery status of the mobile robot 200, mission history of the mobile robot 200 and the like. The processing module 220 may sample one or more memory addresses of the memory module 280 to identify alerts to be sent to a remote device. Such alert may be low battery, failure of the operation unit 240 and the like. Such alert may be sent via the communication module 270. Such remote device may be a dock station or a server, such as a web server.

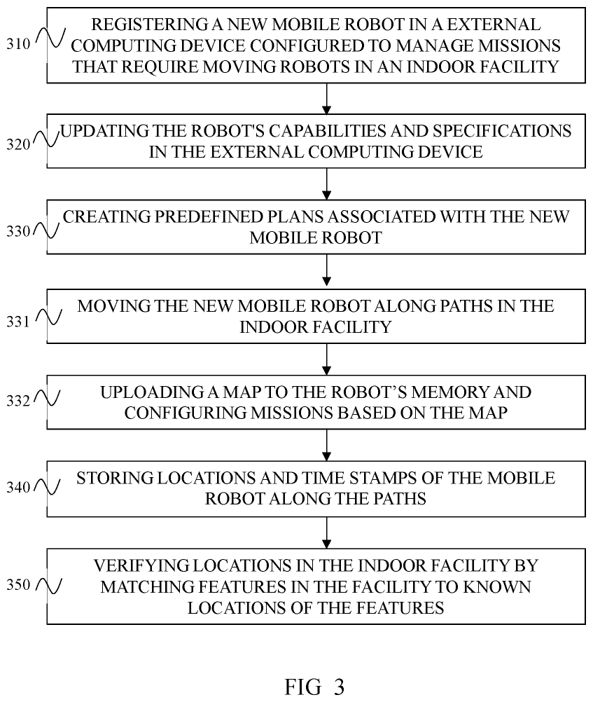

FIG. 3 shows a method for preparing a central computing device and mobile robots with limited navigation capabilities, according to exemplary embodiments of the invention.

Step 310 discloses registering a new mobile robot in a external computing device configured to manage missions that require moving robots in an indoor facility. The external computing device may be part of another computing device, such as a laptop, a tablet, a cellular phone, a computer server and the like. The new mobile robot may be registered on a memory address in the external computing device's memory, for example using an identifier of the robot.

Step 320 discloses updating the robot's capabilities and specifications in the external computing device. The capabilities and specifications (maximum battery time, average battery time, maximum distance, maximum battery time, sensors specs like a field of view, the spectrum of collected light, on-board detection capabilities, communication capabilities and the like.

Step 330 discloses creating predefined plans associated with the new mobile robot. This process may be performed in case the new mobile robot has limited navigation capabilities, for example, the robot cannot independently navigate to a specific location by receiving coordinates. The predefined plans are defined as paths traveled by the mobile robot in the facility along a list of locations that are likely to be used by the mobile robot when performing real-time missions. For example, in case the facility is a warehouse, the predefined plans include the locations of the shelves in the warehouse, windows and doors that enable entrance to or exit from the warehouse, at one or more heights considered relevant to performing the missions.

Step 331 discloses moving the new mobile robot along paths in the indoor facility. Moving the new mobile robot may be done according to a set of commands, such as “during 1.2 seconds, accelerate to a speed of 2 meters per second while moving at an azimuth of 168”, then “for 0.54 seconds, move downwards at a speed of 0.5 meters per second”, then “accelerate to 3 m/s and move at an azimuth of 13” etc. in some cases, the commands are sent from the external computing device over a wireless channel only when the mobile robot reaches a specific destination.

Step 332 discloses uploading a map to the robot's memory and configuring missions based on the map. The map may include objects in the indoor facility, such as doors, ceilings, floors, windows, cabinets, machines and the like. The missions may be in the form of “move to one meter west of window #3”.

Step 340 discloses storing locations and time stamps of the mobile robot along the paths. For example, path #1 may have locations representing coordinates sampled or computed by the external computing device at a sampling rate of 50 samples per second. The coordinates extracted from the robot's paths in the predefined plans phase may be added to a map, for example as an additional layer. In some cases, the external computing device may compute the closest coordinates extracted from the robot's paths in the predefined plans locations in the indoor facility, which are likely to be involved in a mission, such as doors, cabinets, sensors, illumination devices, and the like.

Step 350 discloses verifying locations in the indoor facility by matching features in the facility to known locations of the features. This is an optional phase used to validate the locations of the mobile robot during the predefined plans. The features may include codes that enable computer software to compute the robot's relative direction and location from the code, in case the robot collected data, such as images, that include the code.

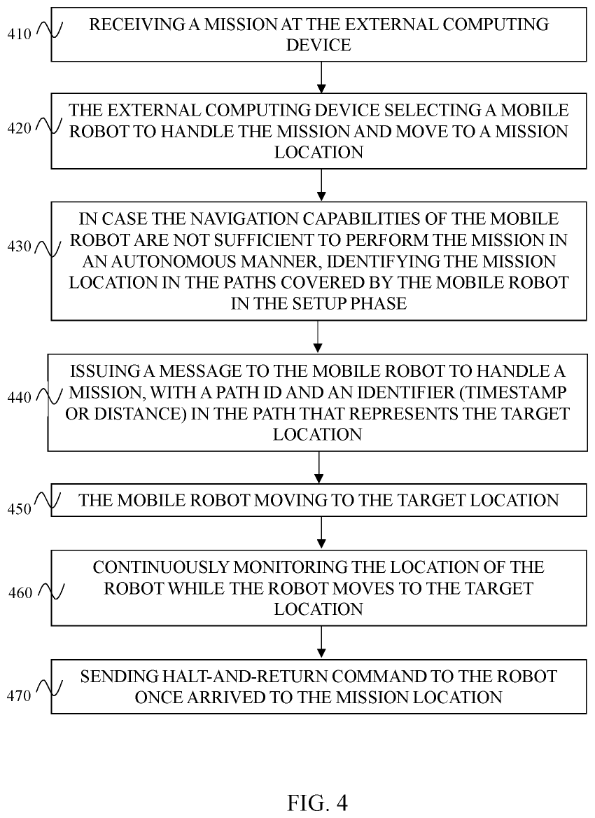

FIG. 4 shows a method for handling missions by a system that comprises a central unit and one or more robots with limited navigation capabilities, according to exemplary embodiments of the invention.

Step 410 discloses receiving a mission at the external computing device. The mission may be initiated from a sensor located in or near the indoor facility, such as a noise sensor, gas sensor, camera, and the like. The mission may be received from a remote device, such as a server or a device located in a remote facility or on a web-based platform such as AWS, Azure and the like. The mission may be performed periodically, for example once every 2 hours. The mission may be assigned an identifier of an object in the indoor facility or a mission location.

Step 420 discloses the external computing device selecting a mobile robot to handle the mission and move to a mission location. The external computing device may first filter a subgroup of robots that can handle the mission based on the mission properties, and then select the mobile robot that is closest to the mission location among the robots in the subgroup.

Step 430 discloses in case the navigation capabilities of the mobile robot are not sufficient to perform the mission in an autonomous manner, identifying the mission location in the paths covered by the mobile robot in the setup phase. In some cases, this process comprises identifying one or more target locations along the paths or on the map that are sufficiently close to the mission location, for example, a target location that is less than 10 centimeters from the mission location. The target location is the location to which the external computing device sends the mobile robot instead of sending the mobile robot to the mission location, which is the optimal location to perform the mission. The mission location itself can be an area, for example, a range of 10-30 centimeters from door #2.

Step 440 discloses issuing a message to the mobile robot to handle a mission, with a path ID and an identifier (timestamp or distance) in the path that represents the target location. For example, “move 72 meters along path number 6”, or “move 16.5 seconds in path number 17, in the same velocities as the predefined plans”.

Step 450 discloses the mobile robot moving to the target location. The movement may be done using an actuator, such as a motor. The movement may be two-dimensional, for example on a floor, or three-dimensional. The movement may be in discrete sessions, in which the robot sends a request to the external computing device for additional instructions when arriving at a certain point in one of the paths.

Step 460 discloses continuously monitoring the location of the robot while the robot moves to the target location. The monitoring may be done using sensors located in the indoor facility that collect information concerning the mobile robot, for example, signal strength of radio signals emitted by the robot, images that include the robot, and the like. The location may be monitored by receiving information from the robot's controller that the robot moved in a certain speed at a certain time duration and a given azimuth.

Step 470 discloses sending halt-and-return command to the robot once arrives to the mission location. The command may include navigation instructions, or simply bring the robot in the same path in which the robot moved to the mission location. The command may comprise an identifier of a docking station onto which the robot is to be docked. In some cases, the “halt and return” command may be managed in the same way as any other mission (turn by turn), in case the robot cannot navigate back to the docking station.

It should be understood that the above description is merely exemplary and that there are various embodiments of the invention that may be devised, mutatis mutandis, and that the features described in the above-described embodiments, and those not described herein, may be used separately or in any suitable combination; and the invention can be devised in accordance with embodiments not necessarily described above.

What is claimed is:

1. A method for defining missions to robots, the method comprising:
creating predefined plans for a mobile robot;
receiving a mission;
computing a mission location for performing the mission;
in case the navigation capabilities of the mobile robot are not sufficient to reach the mission location in an autonomous manner, computing a target location that appears in the predefined plans known to the mobile robot and is sufficiently close to the mission location; and
generating a mission command to be sent to the mobile robot, the mission command comprises a command to perform the mission by moving to the target location,
whereupon the mobile robot moves to the target location.

2. The method of claim 1, wherein performed by an external compute device communicating with multiple mobile robots having different levels of navigation capabilities; said method further comprises identifying the level of navigation capabilities of the mobile robot selected to perform the mission.

3. The method of claim 1, further comprising computing a closest point in the path, wherein the closest point is closest to the mission location, wherein sending the mobile robot to the closest point.

4. The method of claim 1, further comprising computing the closest point along the paths to target objects in the indoor facility, said target objects are likely to be involved in a mission.

5. The method of claim 1, further comprising identifying one or more relevant points in the path, wherein the one or more relevant points have a distance to the mission location, wherein the distance is smaller than a threshold and sending the mobile robot to the closest point.

6. The method of claim 1, further comprising uploading a map to the mobile robot's memory and configuring missions based on the map.

7. The method of claim 1, wherein creating the predefined plans further comprises moving the new mobile robot along paths in the indoor facility.

8. The method of claim 7, further comprising storing locations and time stamps of the mobile robot along the paths.

9. The method of claim 1, further comprising verifying locations in the indoor facility by matching features in the indoor facility to known locations of the features.

10. The method of claim 1, further comprising selecting the mobile robot to handle the mission from multiple optional mobile robots and issuing a mission command based on navigation capabilities of the mobile robot.

11. The method of claim 1, further comprising monitoring the location of the mobile robot while the mobile robot moves to the target location.

12. The method of claim 1, further comprising monitoring the mobile robot while the mobile robot executes the mission and sending additional commands according to messages representing status of the mission over time.
